(19) United States
(12) Patent Application Publication
(10) Pub. No.: US 2003/0197294 A1
(43) Pub. Date: Oct. 23, 2003

(54) Temperature control mechanism and temperature control method for disk molding die

(75) Inventors: Hideaki Shirai, Aichi-ken (JP); Kenji fukumoto, Aishi-ken (JP)

Correspondence Address: BROWDY AND NEIMARK, P.L.L.C., 624 NINTH STREET, NW, SUITE 300, WASHINGTON, DC, 20001-5303, US

(73) Assignee: Kabushiki Kaisha Meiki Seisakusho, Ohbu-shi (JP)

(21) Appl. No.: 10/419,144

(22) Filed: Apr. 21, 2003

(30) Foreign Application Priority Data
Apr. 19, 2002 (JP) 2002-118118

(51) Int. Cl. B29C 45/73; B29D 17/00

(52) U.S. Cl. 264/1.33; 425/552; 425/810; 264/40.6

(57) ABSTRACT

In an injection molding apparatus 62 on which a disk molding die is mounted, wherein the disk molding die is comprised of a stationary die 10 and a movable die 20, a plurality of principal parts of which are separately temperature controlled by media, a control device 50 of the injection molding apparatus 62 is provided with a temperature control mechanism for controlling temperatures of the media which are pumped by a plurality of temperature control devices 51a and 51b in order to control the temperatures of said principal parts.

### BACKGROUND OF THE INVENTION

1. Field of the Invention

The present invention relates to a temperature control mechanism and a temperature control method that can be provided at low cost for temperature controlling the principal parts of a disk molding die quickly, reliably and easily.

2. Description of the Related Art

FIG. 1 shows a known disk molding die 1 in which a temperature control mechanism and a temperature control method according to the prior art and one according to the present invention may be implemented. In FIG. 1, there is shown a stationary die 10, wherein such stationary die 10 is matched with a movable die 20 and outer circumferential rings 36 and 37 and, then, melted resin is injected and filled into a cavity 22 from an injection molding machine (not shown) that abuts on a sprue bush 12. The stationary die 10 is comprised of: a stationary die plate 11 attached to a stationary platen (not shown) of the injection device; the sprue bush 12 inserted through a center opening of the stationary die plate 11; a female cutter 15 attached around a small diameter extension of the sprue bush 12; a stationary specular plate 14 through which the female cutter 15 is inserted; a stationary back plate 13 formed so as to cover a channel B provided by engraving on a surface of the stationary specular plate 14 opposite to the one on which a cavity 22 is formed; and the outer circumferential ring 36.

The movable die 20 is comprised of: a movable die plate 21 attached to a movable platen (not shown) of the injection molding machine; a spacer 28 inserted through a center opening of the movable die plate 21; an inner circumferential stamper holder 27 attached around the spacer 28; an ejector 29, a male cutter 30, a sleeve 32 and an ejector pin 33 which are inserted inside the spacer 28 in succession; a movable specular plate 24 through which the inner circumferential stamper holder 27 is inserted; a movable back plate 23 formed so as to cover a channel D provided by engraving on a surface of the movable specular plate 24 opposite to the one on which a stamper 25 is mounted; and an outer circumferential stamper holder 26 and the outer circumferential ring 37 provided around the circumference of the movable specular plate 24 for holding the outer circumference of the stamper 25.

When the stationary die 10 is matched with the movable die 20, there is formed the cavity 22 which is comprised of each surface or end face of the sprue bush 12, the stationary specular plate 14, the female cutter 15, the stamper 25, the outer circumferential stamper holder 26, the inner circumferential stamper holder 27, the spacer 28, the ejector 29, the male cutter 30, the sleeve 32 and the ejector pin 33. The melted resin that has been injected from the sprue bush 12 into the cavity 22 is cooled by the members constituting said cavity 22 so as to take the form of a disk substrate. Principal parts of each of said members are temperature controlled by circulating media, that are also temperature controlled to predetermined temperatures, through channels. More specifically, the sprue bush 12 is temperature controlled by the channel A formed between the sprue bush 12 and the female cutter 15, the stationary specular plate 14 is temperature controlled by the channel B, the male cutter 30 is temperature controlled by the channel C formed between the sleeve 32, which fits into an internal opening of the male cutter 30, and the male cutter 30 itself, and the movable specular plate 24 is temperature controlled by the channel D, respectively.

The temperature control mechanism in the conventional disk molding die is configured by connecting individual temperature controllers to each of the channels A, B, C and D. More specifically, as shown in FIG. 8, each of temperature controllers 51c is comprised of: a temperature sensor 53 for detecting the temperature of the medium; a pressure sensor 57 for monitoring the pressure of a cooling water source 55 that supplies the medium; a pump 58 for pumping the medium into the channel; a heater 59 for heating the medium to a predetermined temperature; a cooling valve 60 for circulating cooling water through the channel forcibly; and a control section 61. The control section 61 is further comprised of: a temperature control means for feedback controlling the heater 59 so that a value of said temperature sensor 53 is matched with a set value in a setting device provided in the control section 61; and a control means for sequentially activating a temperature control device or performing air bleeding control of the temperature control device, wherein the temperature control device pumps the medium, which is temperature controlled to the predetermined value by the heater 59, into the channel in the die by means of the pump 58 or cools the medium, by means of the cooling valve 60. A commercially available temperature controller may be used as the temperature control means and a sequencer and electromagnetic relays and the like, which are also commercially available, may be used as the control means. In this figure, there are further shown bypass pipes 54 and drains 56.

In the temperature control mechanism in the conventional disk molding die, when the molding operation is started, an operator manipulates activation control switches of the control sections 61 in the temperature controllers 51c individually to activate each of the temperature controllers 51c. Further, after the temperature controllers 51c are activated, in each of the temperature controllers 51c, as shown in the flow chart in FIG. 9, in order to remove air from inside the temperature controllers 51c and the channels A-D in the die, an air bleeding operation is performed by opening/closing the cooling valves 60 based upon commands from the control section 61. More specifically, when the operator pushes the activation control switch of the control section 61 (S21), first, the cooling valve 60 is opened completely (S22) to supply the cooling water to the channels and remove the air from the channels A-D. At this time, the pressure sensor 57 monitors whether the pressure of the cooling water is not less than a predetermined value (0.3 MPa in this example) (S23) and, then, if the pressure of the cooling water is less than the predetermined value, a low pressure alarm is issued (S24) to stop the pump 58 automatically (S25). On the other hand, if the pressure of the cooling water is not less than the predetermined value and can be determined to be normal, the operation of the pump 58 is started (S26) to facilitate the air bleeding and, at the same time, an air bleeding timer starts counting (S27). Next, it is determined whether the air bleeding timer reaches a predetermined set time (1-2 minutes in this example) (S28) and, then, if the predetermined set time is reached or if the condition to finish the air bleeding operation is satisfied, the cooling valve 60 is closed (S29) and, then, the heater 59 is energized to start the temperature control (S30). Here, in S28 above, if the predetermined set time is not reached or if the condition to finish the air bleeding operation is not satisfied, the count of the air bleeding timer is repeated till said predetermined set time is reached.

Further, when the molding operation is finished, as shown in FIG. 10, the operator reduces the set temperature of the temperature setting device in the control section 61 in each temperature controller 51c (S31) to perform a quenching operation and then the temperature controller 51c is stopped. At this time, according to a command from the control section 61, the cooling valve 60 is opened completely so that the cooling water is supplied to the channels A-D to reduce the temperature of the principal parts of the die, which has been about 100° C. When the operator confirms that the temperature of the principal parts of the die is reduced to about 30° C. (S32), the operator pushes a stop switch of each temperature controller 51c (S33) to stop the operation of each temperature controller 51c. Further, when the stamper is replaced, in order to prevent the operator from being burnt, for the stationary specular plate and the movable specular plate that are at relatively high temperature and are likely to be touched, the quenching operation described above is also performed in each temperature controller 51c individually.

As described above, as each temperature controller 51c may be activated or stopped in an arbitrary manner by the operator's manual operation, in some operating conditions, a plurality of the temperature controllers may be activated to perform the air bleeding operation at the same time, as a result of which a large volume of cooling water may be consumed and the pressure of the cooling water may be reduced. If the pressure of the cooling water becomes less than a predetermined value, the pressure sensor 57 issues the low pressure alarm to stop the temperature controller 51c and, thus, the molding operation itself, which may result in a significant reduction of production efficiency. Further, in the disk molding die, as shown in FIG. 1, a clearance 35 between the outer circumferential stamper holder 26 and the stationary specular plate 14 is as small as 10-20 μm and, moreover, when the molding operation is started, as the outer circumferential stamper holder 26 is not temperature controlled directly but is only heated by heat conduction from the movable specular plate 24, the outer circumferential stamper holder 26 shows smaller thermal expansion than the stationary specular plate 14. Therefore, when the molding operation is started, said clearance 35 may become smaller than the value shown above and the outer circumferential stamper holder 26 and the stationary specular plate 14 may abut on each other to create galling. In order to avoid such phenomenon, the temperature controller 51c for the outer circumferential stamper holder 26 or the movable specular plate 24, to which the stamper 25 is attached, has to be activated earlier than the other temperature controller 51c for the stationary specular plate 14.

Further, in the conventional general-purpose temperature controller 51c, as each temperature controller has its dedicated temperature control means and operation control means as well as a temperature control device, such a temperature controller is inevitably expensive. Further, as the stationary specular plate 14, the movable specular plate 24, the sprue bush 12 and the male cutter 30, which are the principal parts of the disk molding die, each need a dedicated temperature controller, the equipment cost is increased.

### SUMMARY OF THE INVENTION

In view of the problems in the prior art as described above, it is an object of the present invention to prevent malfunctions such as a water pressure drop and damage to dies resulted from the manual operation of the plurality of temperature controllers from occurring and to eliminate cost increases or complicated operations and maintenance due to the fact that each principal part of the die is provided with its temperature controller and the plurality of the temperature controllers are each provided with dedicated temperature control means and operation control means of the temperature control devices.

Thus, according to claim 1, in an injection molding apparatus on which a disk molding die is mounted, wherein the disk molding die is comprised of a stationary die and a movable die, principal parts of which are separately temperature controlled by media, there is provided a temperature control mechanism for the disk molding die, wherein a control device of the injection molding apparatus is provided with a temperature control means for controlling a temperature of the media which are pumped by a plurality of temperature control devices in order to control a temperature of each of said principal parts.

According to claim 2, in an injection molding apparatus on which a disk molding die is mounted, wherein the disk molding die is comprised of a stationary die and a movable die, principal parts of which are separately temperature controlled by media, there is provided a temperature control mechanism for the disk molding die, wherein a control device of the injection molding apparatus is provided with a control means for activating or stopping a plurality of temperature control devices to control a temperature of each of said principal parts.

According to claim 3, in the temperature control mechanism for the disk molding die according to claim 2, said control means can activate or stop the temperature control devices in a predetermined order.

Further, according to claim 4, in the temperature control mechanism for the disk molding die according to claim 1 or 2, said principal parts are a stationary specular plate, a movable specular plate, a sprue bush, and a male cutter in the disk molding die.

Still further, according to claim 5, in the temperature control mechanism for the disk molding die according to claim 1 or 2, said temperature control device is configured to include two temperature control devices in an integrally manner, wherein the two temperature control devices have respective temperature control capacities different from each other.

According to claim 6, in a method for temperature controlling an injection molding apparatus on which a disk molding die is mounted, wherein the disk molding die is comprised of a stationary die and a movable die, principal parts of which are separately temperature controlled by media, there is provided a method for temperature controlling the disk molding die, comprising the step of activating or stopping a plurality of temperature control devices to temperature control the respective principal parts in a predetermined order by a control device of the injection molding apparatus.

According to claim 7, in the method for temperature controlling the disk molding die according to claim 6, said predetermined order is such that, at least at the time of activation, the temperature control device for the die having a stamper is activated earlier than the one for the die not having the stamper and, at least at the time of stopping, the temperature control device for the die not having the stamper is stopped earlier than the one for the die having the stamper.

According to claim 8, in a method for temperature controlling an injection molding apparatus on which a disk molding die is mounted, wherein a stationary specular plate and a movable specular plate is temperature controlled by media individually, there is provided a method for temperature controlling the disk molding die, comprising the step of performing a quenching operation by respective temperature control devices for temperature controlling said stationary specular plate and said movable specular plate based upon control by a control device of the injection molding machine.

Further, according to claim 9, in the method for temperature controlling the disk molding die according to claim 8, said quenching operation is performed with a changeover operation to a stamper replacement mode in the control device.

### BRIEF DESCRIPTION OF THE DRAWINGS

FIG. 1 is a transverse cross-sectional view of a disk molding die in which the present invention is implemented;

FIG. 2 is a block diagram showing a temperature control mechanism of the disk molding die according to the present invention;

FIG. 3 is a first flow chart showing a method for activating temperature control devices of principal parts of the disk molding die sequentially;

FIG. 4 is a second flow chart showing the same;

FIG. 5 is a first flow chart showing a method for stopping the temperature control devices of the principal parts of the disk molding die sequentially;

FIG. 6 is a second flow chart showing the same;

FIG. 7 is a flow chart showing a method for performing a quenching operation when a stamper of the disk molding die is replaced;

FIG. 8 is a block diagram showing a temperature control mechanism of a conventional disk molding die;

FIG. 9 is a flow chart showing a conventional air bleeding operation performed when a temperature controller or a temperature control device is activated; and

FIG. 10 is a flow chart showing a conventional method for stopping each temperature control device.

### DESCRIPTION OF THE PREFERRED EMBODIMENTS

Hereinafter, the embodiments of the present invention will be described with reference to the drawings.

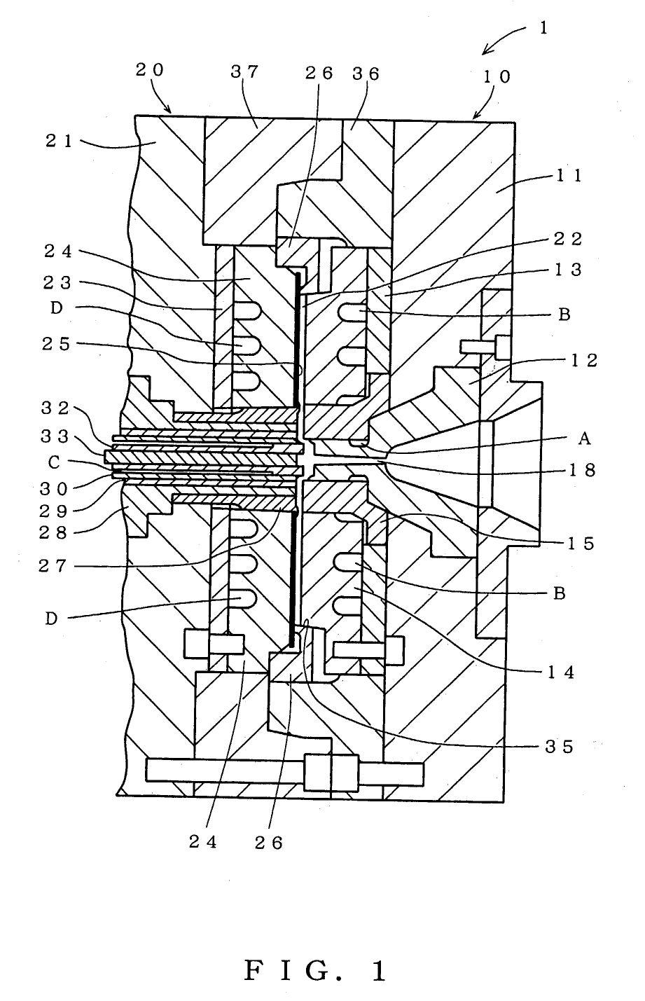

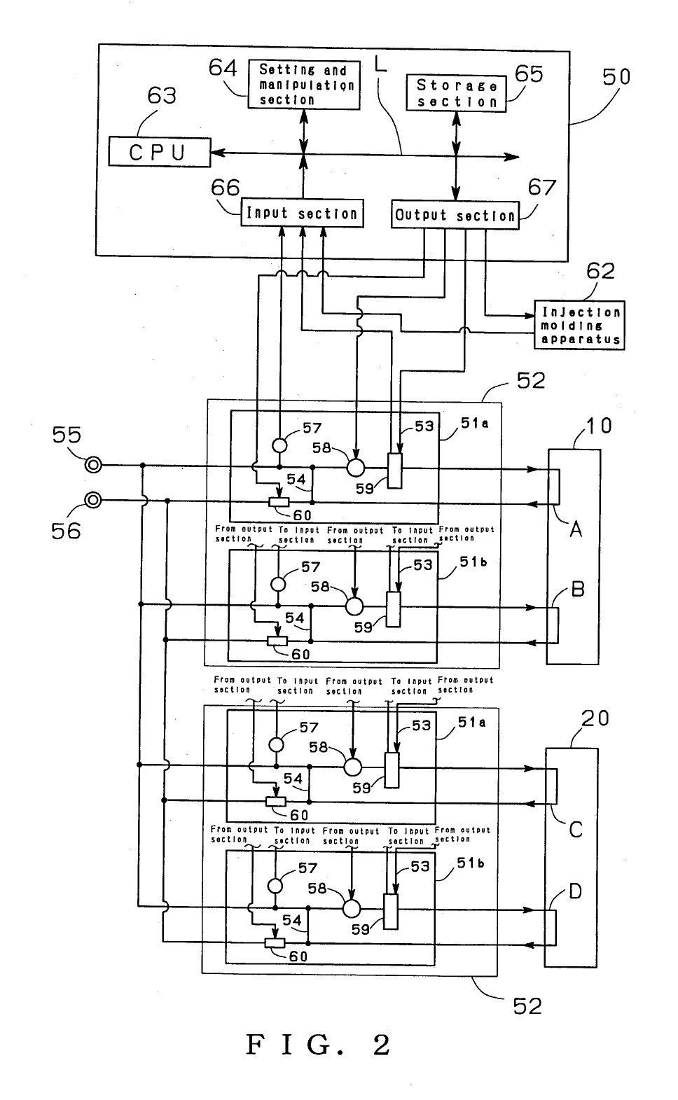

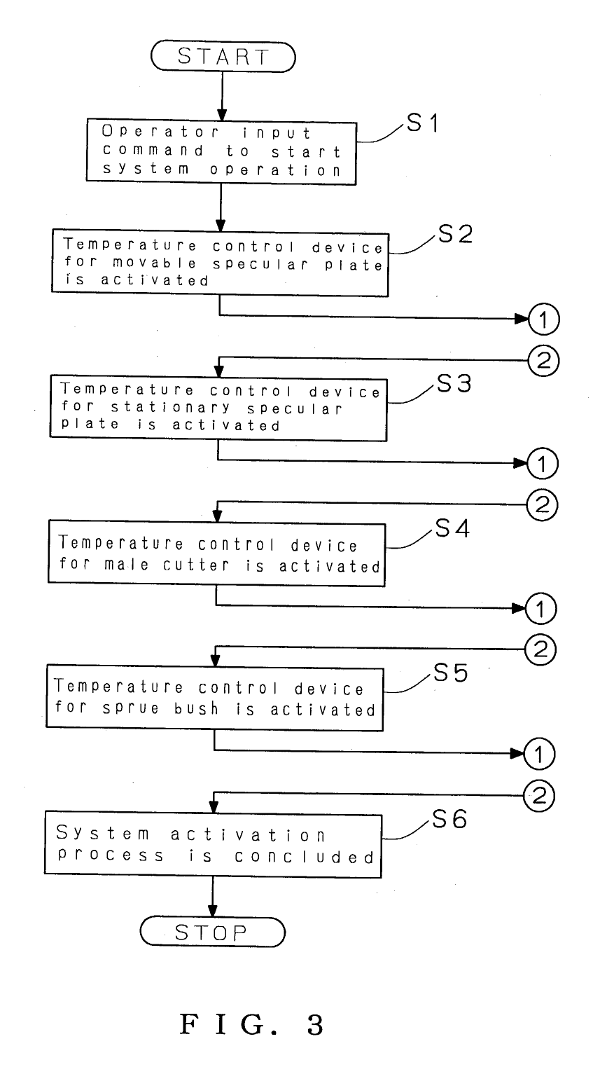

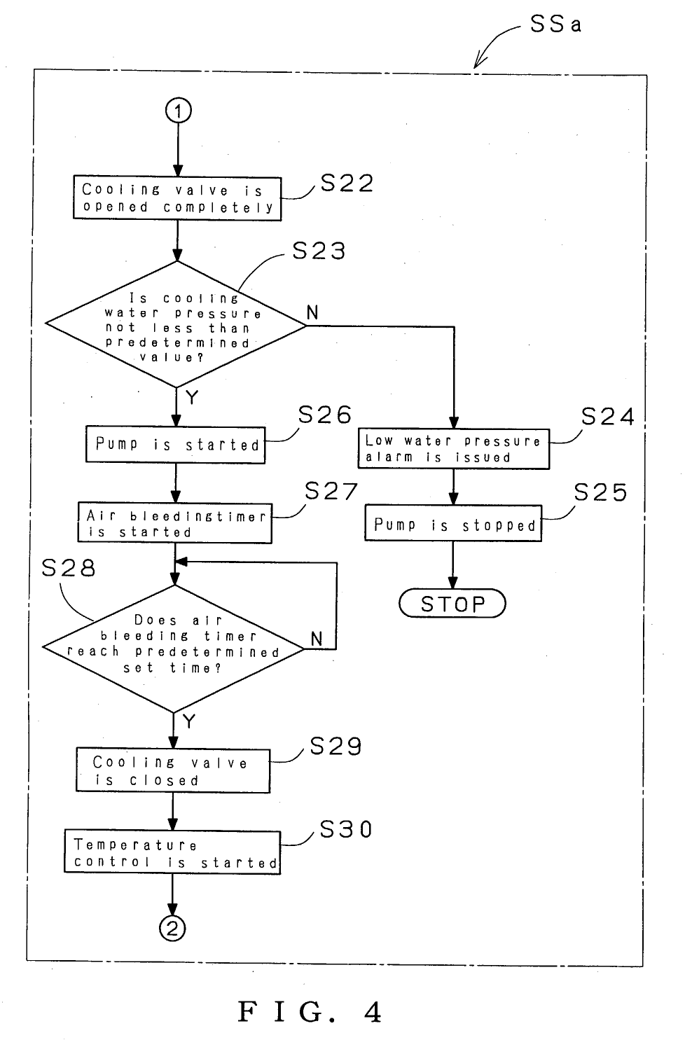

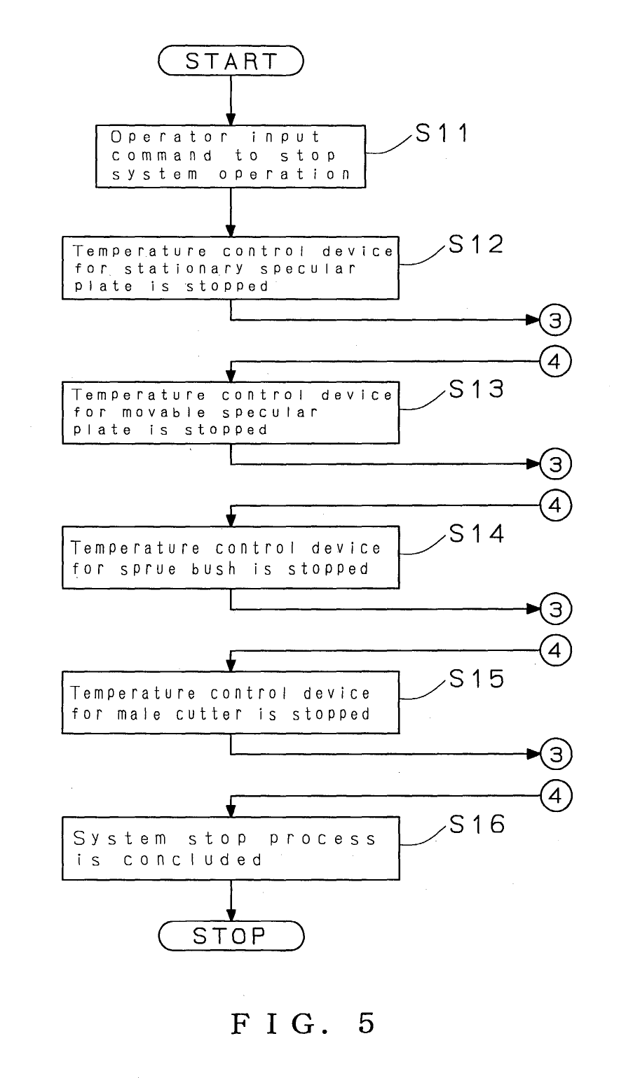

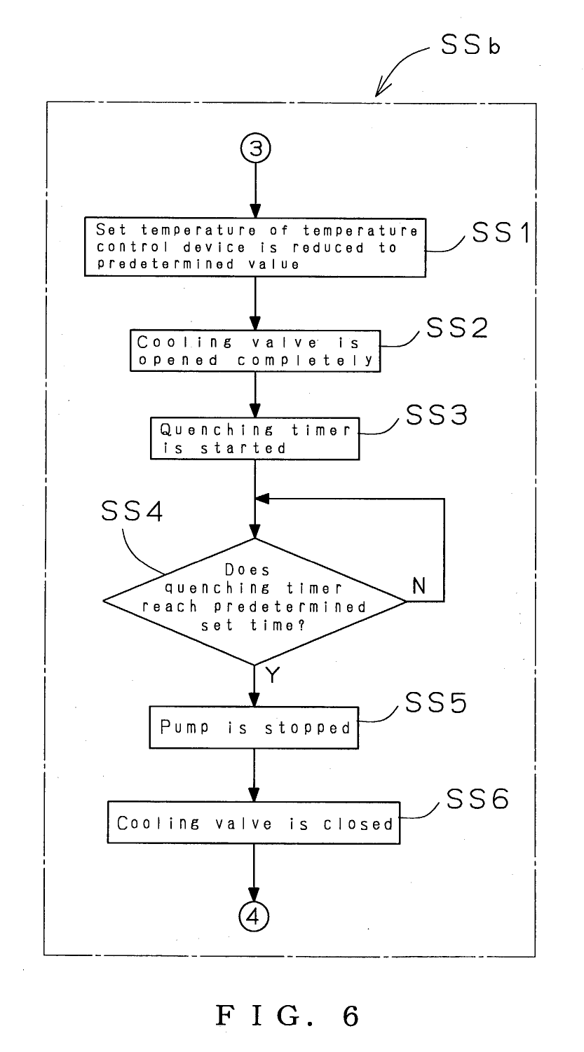

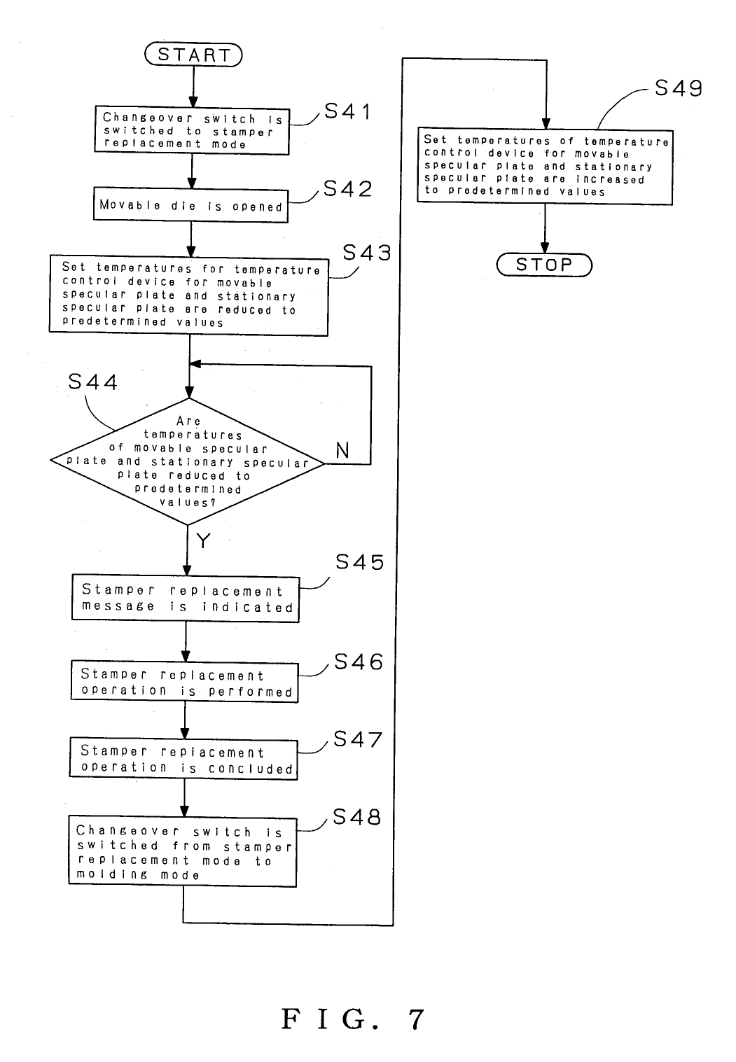

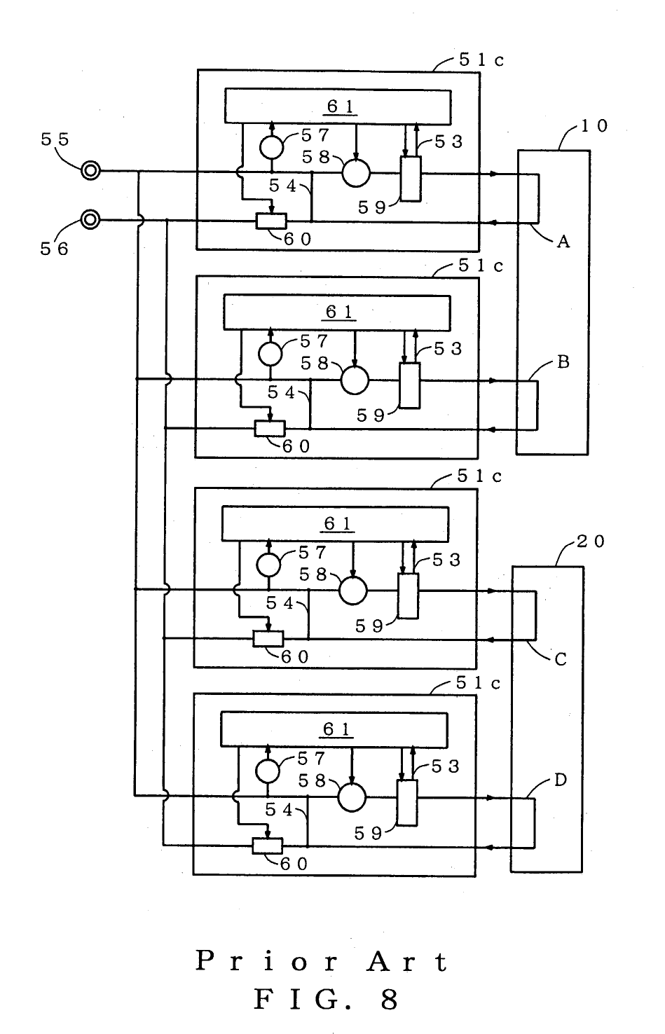

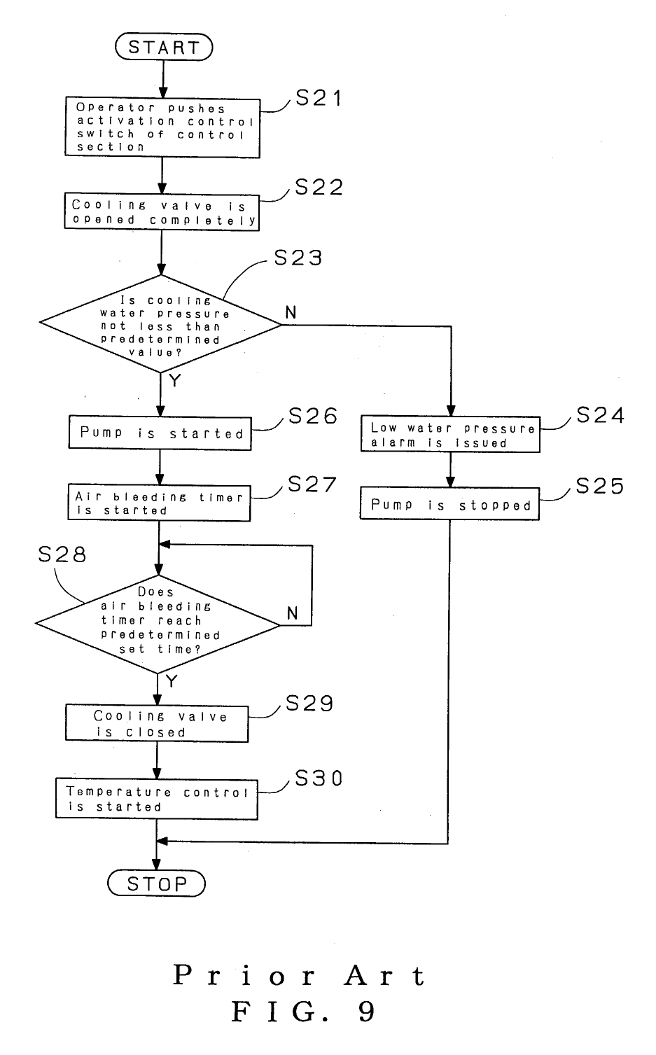

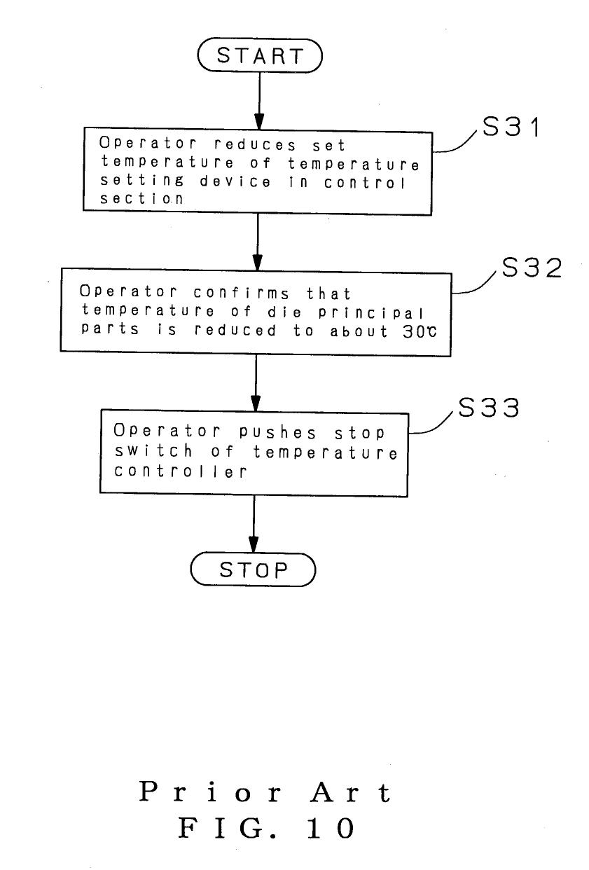

FIG. 1 is a transverse cross-sectional view of a disk molding die in which the present invention is implemented, FIG. 2 is a block diagram showing a temperature control mechanism of the disk molding die according to the present invention, FIG. 3 is a first flow chart showing a method for activating temperature control devices of principal parts of the disk molding die sequentially, FIG. 4 is a second flow chart showing the same, FIG. 5 is a first flow chart showing a method for stopping the temperature control devices of the principal parts of the disk molding die sequentially, FIG. 6 is a second flow chart showing the same, FIG. 7 is a flow chart showing a method for performing a quenching operation when a stamper of the disk molding die is replaced, FIG. 8 is a block diagram showing a temperature control mechanism of a conventional disk molding die, FIG. 9 is a flow chart showing a conventional air bleeding operation performed when a temperature controller or a temperature control device is activated, and FIG. 10 is a flow chart showing a conventional method for stopping each temperature control device.

As shown in FIG. 1, a disk molding die 1, in which the present invention is implemented, is comprised of a stationary die 10 and a movable die 20 and is identical to the one described as the prior art. Therefore, in order to avoid overlaps, its detailed description is omitted.

With reference to FIG. 2, a temperature control mechanism for principal parts of the disk molding die will be described in detail. Each of temperature control devices 51a and 51b is comprised of: a temperature sensor 53 for detecting a temperature of a medium; a pressure sensor 57 for monitoring a pressure of a cooling water source 55 that supplies the medium; a pump 58 for pumping the medium into channels; a heater 59 for heating the medium to a predetermined temperature; and a cooling valve 60 for forcibly circulating cooling water through the channels. The cooling water source 55 is an industrial waterworks having a pressure of about 1 MPa and the like. A line from the cooling water source 55 is branched into the pressure sensor 57, the pump 58 and a bypass line 54. For example, in the temperature control device 51a for the sprue bush 12, a discharge line from the pump 58 is connected to the heater 59 and the medium heated in the heater 59 is output from the temperature control device 51a and undergoes heat exchange in the channel A in the stationary die 10 and then is returned to the temperature control device 51a again. A return line is branched into the bypass line 54 and the cooling valve 60. A line from the cooling valve 60 is connected to a drain 56. In a normal temperature control operation, the cooling valve 60 is closed and the medium is passed through the bypass line 54 to circulate in the channel A. In a quenching operation, the cooling valve 60 is opened to release the heated medium into the drain 56.

Temperature control devices 51a and 51b for other channels (channels B-D) are configured in an identical manner to the temperature control devices 51a and 51b described above. Therefore, in the description of the temperature control devices 51a and 51b in FIG. 2, only the internal configuration of one temperature control device 51a is described in detail and the description of other three temperature control devices 51a and 51b is omitted. However, with regard to the ratings of a discharge rate and heater electric power of the pump 58 and/or the heater 59, respectively, in the temperature control devices 51a and 51b, the pump 58 and/or the heater 59 of different ratings may be adopted so as to constitute a rational system in which the capacity of the temperature control device is compliant with a thermal capacity of the temperature control target. More specifically, the sprue bush 12 corresponding to the channel A and the male cutter 30 corresponding to the channel C have a relatively low heat capacity and, on the other hand, the stationary specular plate 14 corresponding to the channel B and the movable specular plate 24 corresponding to the channel D have a relatively large thermal capacity. Therefore, it is preferable that the temperature control devices 51a for the channels A and C have a relatively low temperature control capacity and the temperature control devices 51b for the channels B and D have a relatively high temperature control capacity. Further, each of the temperature control devices 52 is constituted by combining the temperature control device 51a having the relatively low temperature control capacity and the temperature control device 51b having the relatively high temperature capacity together integrally. As a result, as, in total, two identical temperature control devices 52, one of which is for the stationary die 10 and the other of which is for the movable die 20, are sufficient, the temperature control devices can be installed easily even in a narrow space and, moreover, commonality of parts can be increased and maintenance and daily inspections can be facilitated.

The pressure sensor 57 monitors whether the water pressure is less than a lower limit so as to protect the pump 58, prevent the heater 59 from being energized without the medium, and ensure an upper limit temperature at which the temperature control is possible. The pressure sensor 57 transmits a signal indicating the pressure of the cooling water, as a medium, to an input section 66 of the control device 50 and, then, the control device 50 compares the signal with the lower limit value of the cooling water pressure set therein to issue a low water pressure alarm. However, the pressure sensor 57 may alternatively have the feature for comparing the signal with the lower limit value described above and the pressure sensor 57 may transmit the low water pressure alarm to the control device 50.

Further, though the pressure sensor 57 is provided in each temperature control device 51a and 51b in the above description, as all the pumps 58 of the temperature control devices 51a and 51b are connected to the same cooling water source 55, it may be sufficient that the pressure sensor 57 is provided only in any one of the four temperature control devices 51a and 51b and, thus, such a configuration may be possible.

The control device 50 is configured on the basis of a microprocessor and comprised of a CPU 63, a setting and manipulation section 64, a storage section 65, the input section 66, and an output section 67. The control device 50 first performs sequence control over the entire operation of the injection molding apparatus 62 and, moreover, provides overall control over the temperature of a heating cylinder, the speed, force, positions and the like of actuators in the injection unit, a die clamping device and so on.

The CPU 63 is connected to the setting and manipulation section 64, the storage section 65, the input section 66, and the output section 67 via a bus line L, so that results are acquired by calculating and controlling based upon: signals input from the input section 66 such as pressures, temperatures, positions, times and speeds; control programs and constants stored in the storage section 65; and command values configured in the setting and manipulation section 64 and stored in the storage section 65 temporarily as well as command signals manipulated and input in the setting and manipulation section 64 and, then, the results are output from the output section 67 to the injection molding apparatus 62 and the temperature control devices 51a and 51b.

The setting and manipulation section 64 is disposed at a position that is located at the center of the injection molding apparatus 62 where the overall operational conditions can be understood well, such as at the side of a stationary platen of the injection molding apparatus 62. The setting and manipulation section 64 is comprised of a CRT or a liquid crystal display as well as a touch panel provided on a surface of the display, and push button switches and selector switches for manual operation, wherein such elements are disposed integrally for ease of operation. The screen of the display is designed so that the pressures, temperatures, positions, times and speeds and the like of each actuator of the injection molding apparatus 62 can be set and instructed through the touch panel. Further, the setting and manipulation section 64 also has a feature for displaying the pressures, temperatures, positions, times and speeds and the like of the actuators in the form of digital numeric values or graphs and a feature for displaying alarm messages.

The storage section 65 is comprised of a RAM for temporarily storing set values input through the setting and manipulation section 64, and a ROM for storing the control programs, constants and the like in a nonvolatile manner. In addition, the storage section 65 includes an external storage section such as floppy disks and card-like storage media for storing molding conditions set for each die for subsequent molding operations.

The input section 66 receives analog signals or digital signals from the sensors of the injection molding apparatus and the temperature control devices 51a and 51b, eliminates noise and, then, in case of analog signals, processes the signals by amplification, level conversion and the like and then converts them to the digital signals and, then transmits the signals to the CPU 63. For example, the input section 66 processes the pressure signals from the pressure sensors 57 as described above, but, for thermocouple signals such as those from the temperature sensors 53, cold junction compensation is needed and the input section 66 also has such feature.

The output section 67 outputs an opening/closing current for activating/stopping hydraulic direction switching valves of the injection molding apparatus 62 and the cooling valves 60 and the pumps 58 of the temperature control devices 51a and 51b, and an analog current for activating electromagnetic proportional valves and servomotors of the injection molding apparatus 62.

The temperature control mechanism of the control device 50 is identical to the temperature control mechanism of the heating cylinder of the injection molding apparatus 62 wherein, more specifically, a spare portion or an additional input circuit board of the input section 66 of the thermocouple of the heating cylinder and a spare portion or an additional output circuit board of the output section 67 for controlling the switches to open/close the circuit to the heater for the heating cylinder are used as hardware and the program for feedback controlling the temperature of the heater for the heating cylinder is used as software. Thus, according to the control method implemented as the temperature control means, the CPU 63 controls the heaters 59 via the output section 67 according to the temperature control program stored in the storage section 65 so that the temperatures of the media detected by the temperature sensors 53 via the input section 66 are matched with the set values of the media temperatures set by the setting and manipulation section 64. Further, the control means is constituted by using a portion of the sequence control of the injection molding apparatus 62.

Next, with reference to the flow chart in FIGS. 3 and 4, a method for increasing the temperatures of the principal parts of the disk molding die by sequentially activating the temperature control devices will be described. Such control is performed by the control means. The control means performs the sequential activation or air bleeding operation of the temperature control devices for pumping the media, which are temperature controlled to predetermined values by the heaters 59, to the channels A-D of the die by means of the pumps 58 and for cooling the media by means of the cooling valves 60. First, the operator manipulates the setting and manipulation section 64 to input a command to start the operation of this temperature control mechanism (system) (S1). Then, an activation process of the temperature control device for the movable specular plate is started (S2). The specific steps are shown in a subroutine SSa, though the subroutine SSa is identical to the steps S22-S30 in the air bleeding operation in the prior art (FIG. 9), the detailed description of which is omitted. When the temperature control of the temperature control device for the movable specular plate is started and the activation process of the temperature control device for the movable specular plate is terminated, the temperature control device for the stationary specular plate is activated (S3) and, then, the process enters into the subroutine SSa again. After that, in a similar manner, the temperature control device for the male cutter is activated (S4) and the temperature control device for the sprue bush is activated (S5) sequentially and, then, the activation process of the temperature control mechanism (system) is concluded (S6), which is the end of the process for increasing the temperatures of the principal parts of the disk molding die. Here, it is to be noted that the air bleeding timer may be set to about 1-2 minutes in the subroutine SSa, but in the case of the temperature control device having a relatively high temperature control capacity, a longer time may be needed. Further, as described above, when the stamper 25 is mounted on the movable specular plate 24, unless the movable specular plate 24 is activated faster than the stationary specular plate 14 by a predetermined time period (for example, about two minutes), galling may occur between the stationary specular plate 14 and the outer circumferential stamper holder 26 in the clearance 35 and, therefore, the time setting of the air bleeding timer may be provided for the delay of the heating time or another timer for setting the delay time may be provided.

It is to be noted that the activation sequence of said temperature control devices 51a and 51b for the principal parts of the die described above is only an example and is not limited to such embodiment. For example, the temperature control device for the movable specular plate is activated earlier than the temperature control device for the stationary specular plate when the stamper 25 is mounted on the movable specular plate 24, but, in the configuration shown in FIG. 1, in which the stationary specular plate 14 and the movable specular plate 24 are interchanged with each other and the stamper 25 is mounted on the stationary specular plate, the temperature control device for the stationary specular plate may be activated earlier than the temperature control device for the movable specular plate. Further, as the sprue bush 12 and the male cutter 30 may have a substantially similar heat capacity and it does not matter which of them is activated first, either the temperature control device for the sprue bush or the temperature control device for the male cutter may be activated first, if only after the temperature control device for the stationary specular plate and the temperature control device for the movable specular plate are activated.

Next, with reference to the flow chart in FIGS. 5 and 6, a method for reducing the temperatures of the principal parts of the disk molding die by sequentially stopping the temperature control devices will be described. Such control is performed by the control means and the temperature control means. First, the operator manipulates the setting and manipulation section 64 to input a command to stop the operation of this temperature control mechanism (system) (S11). It starts the stopping process of the temperature control device for the stationary specular plate (S12). Its specific steps are shown in a subroutine SSb. The subroutine SSb shows a sequence in which the prior art method for stopping the temperature controller 51c manually (FIG. 9) is performed collectively and automatically by the control device 50 of the injection molding apparatus 62. First, in step SS1, in the temperature control means of the temperature control devices 51a and 51b for each principal part of the die, the set temperature value for the target principal part is replaced with a predetermined value that is a relatively low temperature value (40° C. in this embodiment) stored in the storage section 65 to reduce the set temperature value in the temperature control devices 51a and 51b to said predetermined value. Then, the electric power supply to the heater 59 is turned off and the cooling valve 60 is opened completely (SS2) and, further, a quenching timer starts counting (SS3). Next, it is determined whether the quenching timer reaches a predetermined set time (5 minutes in this embodiment) (SS4) and, then, if the predetermined set time is reached or if the condition to finish the quenching operation is satisfied, the pump 58 is stopped (SS5) and, further, the cooling valve 60 is closed (SS6). On the other hand, if the predetermined set time is not reached or if the condition to finish the quenching operation is not satisfied in SS4 above, the count of the quenching timer is repeated till said predetermined set time is reached. Here, in step SS4, the temperature reduction of the principal part of the die is confirmed by means of the quenching timer, but, taking into consideration that the temperature reduction is confirmed by the operator watching the temperature indicated on the temperature control device in the prior art method, the step SS4 may be modified so that a signal is issued when the actual measured temperature of the medium in the temperature control means is reduced to a predetermined value.

When the stopping process of the temperature control device for the stationary specular plate is concluded, then, the stopping process of the temperature control device for the movable specular plate is started (S13). Also in the stopping process of the temperature control device for the movable specular plate, the process of the subroutine SSb is performed again. After that, in a similar manner, the stopping process of the temperature control device for the sprue bush (S14) and the stopping process of the temperature control device for the male cutter (S15) are performed successively and, then, the stopping process of the temperature control mechanism (system) is concluded (S16), which is the end of the process for reducing the temperatures of the principal parts of the disk molding die.

It is to be noted that said stopping sequence of the temperature control devices 51a and 51b for the principal parts of the die described above is only an example and is not limited to such embodiment. For example, the temperature control device for the stationary specular plate is stopped earlier than the temperature control device for the movable specular plate when the stamper 25 is mounted on the movable specular plate 24, but, in the configuration in which the stationary specular plate 14 and the movable specular plate 24 are interchanged with each other and the stamper 25 is mounted on the stationary specular plate, the temperature control device for the movable specular plate may be stopped earlier than the temperature control device for the stationary specular plate. Further, as the sprue bush 12 and the male cutter 30 may have a substantially similar heat capacity and it does not matter which of them is cooled first, either the temperature control device for the sprue bush or the temperature control device for the male cutter may be stopped first, if only after the temperature control device for the stationary specular plate and the temperature control device for the movable specular plate are activated. Still further, in the case of the stopping process of the temperature control devices 51a and 51b for the principal parts of the die, as the die may not be opened or closed immediately after the stopping process and, therefore, it is often not necessary to pay attention to the galling problem, the stopping sequence of the temperature control device for the movable specular plate and the temperature control device for the stationary specular plate may not be specified and these temperature control devices may be stopped at the same time.

As an example of such operation, a quenching operation of the principal parts of the disk molding die at the time of replacement of the stamper 25 or at the time of maintenance and inspections of members constituting the cavity 22 will be described with reference to the flow chart shown in FIG. 7. The stamper 25 is used for transferring information in the form of pits to disk substrates such as a CD, a DVD and the like and, the stamper 25 is replaced with another stamper 25 having other information after a desired quantity of disk substrates are produced. At this time, after the movable die 20 is moved away from the stationary die 10 to reserve a large working area around the cavity 22 and the outer circumferential stamper holder 26 and the inner circumferential stamper holder 27 are removed, the stamper 25 is replaced. At this time, it is possible that the operator may touch the stationary specular plate 14 and the movable specular plate 24, which are heated to about 100° C., and may be burnt. Therefore, when the stamper 25 is replaced, the stationary specular plate 14 and the movable specular plate 24 must be quenched to about 50° C.

When the stamper 25 is replaced, a changeover switch provided in the setting and manipulation section 64 is switched from the molding mode to the stamper replacement mode (S41). As its result, according to a program for replacing the stamper that is stored in the storage section 65 in advance, the control device 50 controls the injection molding apparatus 62 and the temperature control devices 51a and 51b as described below. In step S42, the movable die 20 is moved away from the stationary die 10 at a relatively low speed so that a large working area that is sufficient for the replacement of the stamper 25 is formed. And, at the same time, in step S43, the set temperatures for the temperature control device for the movable specular plate and the temperature control device for the stationary specular plate are replaced with the predetermined values stored in the storage section 65 in advance so as to reduce said set temperatures to the predetermined values. The predetermined values are lower than the set values for the molding mode and are typically about 50° C. Further, the other temperature control devices (the temperature control device for the male cutter and the like) may be changed into such a value (about 50° C.) to allow the other temperature control devices to perform the quenching operation along with the temperature control device for the movable specular plate and the temperature control device for the stationary specular plate. Still further, in order to protect specular surfaces of the die, the process for opening the movable die in step S42 may alternatively be performed after step S44.

As the set temperatures of the temperature control device are reduced to said predetermined values, the electric power supply to the heater 59 is turned off, the cooling valve 60 is opened or closed according to the temperature values of the media detected by the temperature sensor 53, the cooling water is supplied to the channels B and D of the die to cool the principal parts of the die and, then, the temperatures of the principal parts of the die are temperature controlled to the predetermined values for replacing the stamper. Next, when the temperatures of the medium for the temperature control device for the movable specular plate and the medium for the temperature control device for the stationary specular plate, which are detected by the temperature sensor 53, are reduced to the predetermined values, it is determined whether the temperatures of the movable specular plate 24 and the stationary specular plate 14 are reduced to the predetermined values or not (S44) and, then, if the temperatures are reduced to the predetermined values (about 50° C. in this example), a stamper replacement message indicating that the stamper can be replaced may be shown on the display of the setting and manipulation section 64, or a voice message indicating that the stamper can be replaced may be issued. On the other hand, if it is determined that the temperatures of the movable specular plate 24 and the stationary specular plate 14 are not reduced to said predetermined values in said S44, such a determination process repeated till the temperatures of the movable specular plate 24 and the stationary specular plate 14 are reduced to the respective predetermined values. After the cooling process for the movable specular plate 24 and other principal parts is concluded, the operation for replacing the stamper itself is concluded (S46) and the entire operation for replacing the stamper is concluded (S47), if the molding operation is started again, said changeover switch provided in the setting and manipulation section 64 is switched from the stamper replacing mode to the molding mode (S48). As its result, the set temperatures for the temperature control device for the movable specular plate and the temperature control device for the stationary specular plate are replaced with the predetermined value (100° C. in this embodiment), which is stored as the molding condition in the storage section 65 in advance, so as to increase the temperatures of the principal parts of the die (S49) and, thus, the quenching process of the principal parts of the disk molding die is concluded. Here, it is to be noted that, in the stamper replacing mode, the automatic molding operation is prevented by a safety-interlock provided by the control means.

Although the present invention has been described as related to the embodiment shown in the accompanying drawings, it is to be understood that the present invention is not limited to the embodiment described above and that various changes may be made without departing from the sprit and scope thereof.

According to claim 1, as the control device of the injection molding apparatus is provided with the temperature control means for controlling the temperatures of the media, the complicated operations for setting and manipulating the temperatures of the principal parts of the disk molding die by the individual temperature controllers become unnecessary and the low-cost temperature control mechanism can be implemented.

According to claim 2, as the control device of the injection molding apparatus is provided with the control means for activating or stopping a plurality of the temperature control devices for controlling the temperatures of the principal parts of the disk molding die at one time, the complicated operations for activating or stopping the temperature control devices individually become unnecessary and the low-cost temperature control mechanism can be implemented.

According to claim 3, as the temperature control devices can be activated or stopped in a predetermined order, the pressure drop of the cooling water, which may occur when the plurality of the temperature control devices are activated at the same time, can be prevented effectively and, therefore, production efficiency can be improved and damage to the die can be prevented from occurring.

According to claim 4, as the principal parts of the disk molding die, which are important for the molding operation and are the stationary specular plate, the movable specular plate, the sprue bush and the male cutter, form almost all of the cavity and the sprue and these members can be temperature controlled individually and in an appropriate order, disk substrates of good quality can be molded efficiently and safely.

According to claim 5, as two temperature control devices, which have respective temperature control capacity different from each other, are housed integrally, the housing can be shared and down sized so that the housing can be installed in a small area and, at the same time, the commonality of the parts can be increased by selecting the parts that are appropriate for the temperature control target to eliminate waste and, therefore, the cost of the temperature control devices can be reduced.

According to claim 6, as a plurality of the temperature control devices for controlling a plurality of the principal parts of the stationary die and the movable die can be activated or stopped in a predetermined order by the control device of the injection molding apparatus, the complicated operations for activating or stopping the temperature control devices individually become unnecessary and, as a result, the physical and mental burden on the operator can be reduced and operational mistakes can be eliminated and, further, the interruption of the operation due to any alarm signal such as the low water pressure alarm, which may result in poor production efficiency and the damage to the die, can also be eliminated.

According to claim 7, as the order to activate or stop the temperature control devices is configured so that, at the time of activation, at least the temperature control device for the die having the stamper is activated earlier than the one for the die not having the stamper and, at the time of stopping, at least the temperature control device for the die not having the stamper is stopped earlier than the one for the die having the stamper, the galling resulting from the difference of thermal expansion in the small clearance between the die members can be prevented when the temperature control devices are activated or stopped to increase or reduce the temperature of the disk molding die.

According to claim 8, as the temperature control devices for controlling the temperatures of the stationary specular plate and the movable specular plate perform the quenching operation based upon the control by the control device of the injection molding apparatus, the quenching operation of the die can be performed easily and quickly so as to ensure safety operations, such as protecting the operator from being burnt, when the operator approaches or touches the die cavity surface at the time of stamper replacement and so on.

According to claim 9, as the quenching operation is performed with the changeover operation to the stamper replacement mode in the control device, the stamper replacement operation can be performed safely and accurately in association with the operation of the injection molding apparatus.

What is claimed is:

1. In an injection molding apparatus on which a disk molding die is mounted, wherein the disk molding die is comprised of a stationary die and a movable die, plural principal parts of which are temperature controlled by media individually,
a temperature control mechanism for the disk molding die, wherein a control device of the injection molding apparatus is provided with a temperature control means for controlling temperatures of the media which are pumped by a plurality of temperature control devices in order to control temperatures of said principal parts.

2. In an injection molding apparatus on which a disk molding die is mounted, wherein the disk molding die is comprised of a stationary die and a movable die, principal parts of which are temperature controlled by media individually,
a temperature control mechanism for the disk molding die, wherein a control device of the injection molding apparatus is provided with a control means for activating or stopping a plurality of temperature control devices to control a temperature of each of said principal parts.

3. A temperature control mechanism for the disk molding die according to claim 2, wherein said control means can activate or stop the temperature control devices in a predetermined order.

4. A temperature control mechanism for the disk molding die according to claim 1, wherein said principal parts are a stationary specular plate, a movable specular plate, a sprue bush, and a male cutter in the disk molding die.

5. A temperature control mechanism for the disk molding die according to claim 1, wherein said temperature control device is configured to include two temperature control devices in an integral manner, wherein the two temperature control devices have respective temperature control capacities different from each other.

6. A temperature control mechanism for the disk molding die according to claim 2, wherein said principal parts are a stationary specular plate, a movable specular plate, a sprue bush, and a male cutter in the disk molding die.

7. A temperature control mechanism for the disk molding die according to claim 2, wherein said temperature control device is configured to include two temperature control devices in an integral manner, wherein the two temperature control devices have respective temperature control capacities different from each other.

8. A method for temperature controlling an injection molding apparatus on which a disk molding die is mounted, said disk molding die being comprised of a stationary die and a movable die, the principal parts of which are temperature controlled by media individually, wherein
a plurality of temperature control devices to temperature control the respective principal parts are activated or stopped in a predetermined order by a control device of the injection molding apparatus.

9. A method for temperature controlling the disk molding die according to claim 8, wherein said predetermined order is such that, at the time of activation, at least the temperature control device for the die having a stamper is activated earlier than the one for the die not having the stamper and, at the time of stopping, at least the temperature control device for the die not having the stamper is stopped earlier than the one for the die having the stamper.

10. A method for temperature controlling an injection molding apparatus on which a disk molding die is mounted, said disk molding die being comprised of a stationary die and a movable die which have a stationary specular plate and a movable specular plate that are temperature controlled by media individually, wherein
a quenching operation is performed by respective temperature control devices for temperature controlling said stationary specular plate and said movable specular plate based upon control by a control device of the injection molding machine.

11. A method for temperature controlling the disk molding die according to claim 10, wherein said quenching operation is performed with a changeover operation to a stamper replacement mode in the control device.
